(19) United States
(12) Patent Application Publication
(10) Pub. No.: US 2026/0072724 A1
(43) Pub. Date: Mar. 12, 2026

(54) Priori Promotion Of Local Transactions To Distributed Transactions

(71) Applicant: Oracle International Corporation, Redwood Shores, CA (US)

(72) Inventors: Todd J. Little, Lafayette, CO (US); Pruthvithej Ramesh Kumar, Bangalore (IN); Tushar Shaily, Bangalore (IN)

(21) Appl. No.: 18/829,122

(22) Filed: Sep. 9, 2024

(51) Int. Cl. G06F 9/46; G06F 9/50

(52) U.S. Cl. CPC G06F 9/466; G06F 9/5072

(57) ABSTRACT

A mechanism is provided to attempt to avoid the overhead of using a distributed transaction when involvement of a transaction manager is unnecessary. A service initiates a local transaction with its associated resource manager. When the service communicates with another service, it becomes possible that a full distributed transaction may be required. In response to the initiating service communicating with another service, the local transaction is promoted to a distributed transaction.

### FIELD OF THE INVENTION

The present invention relates to performing transactions using services and resource managers and, more particularly, to a priori promotion of local transactions to distributed transactions.

### BACKGROUND

Modern applications are built by composing a few services that are independently developed. A service is an architectural approach to software development that breaks large applications into smaller, independent services that communicate through application programming interfaces (APIs). Each service has its own responsibility and can communicate with other parts through simple interfaces. This provides agility and speed to market for fixing issues and introducing new features. This paradigm is often referred to as a microservices architecture, although the number of services that come together for a complete application can be in the hundreds (microservices), or in the tens (macroservices). As used herein, the term “service” may refer to a microservice or a macroservice. In a microservices architecture, each service owns a simple task and communicates with clients or other services using communication mechanisms such as representational state transfer (REST) APIs.

Each service may communicate with one or more resource managers to perform operations. A resource manager is a managed service that automates deployment and operations for a resource, such as a database. The services are typically developed and deployed independently, each with its own resource managers. When a business transaction spans multiple services, it is likely necessary that some mechanism be in place to ensure that updates in these services occur atomically, i.e., either all updates occur or none of them occur. A transaction manager simplifies application development and operations by enabling distributed transactions to ensure consistency across services and resource managers.

Services communicate with the transaction manager using the REST API. These REST calls have a small overhead but are unnecessary if a transaction can be executed as a local transaction using a single service with its own resource manager. However, it is difficult to determine what services will be involved in a transaction. This also means that it is very difficult to determine whether multiple resource managers must be updated in a business transaction as each service may use its own resource manager. The simple or naïve solution is to always start a distributed transaction in case multiple data sources are updated. However, this incurs a lot of additional overhead for business transactions that do not update multiple resource managers. Thus, there is a need for a mechanism to allow a transaction that uses a single service to be executed as a local transaction and to only promote the transaction to a distributed transaction when it might be required.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a microservices architecture in which aspects of the embodiments can be implemented.

FIG. 2 is a block diagram illustrating the use of interceptors in accordance with an embodiment.

FIG. 3A is a block diagram illustrating extended architecture communication between an initiator service and a resource manager in accordance with an embodiment.

FIG. 3B is a block diagram illustrating a resource manager proxy for extended architecture transaction management between an initiator service and a resource manager in accordance with an embodiment.

FIG. 4 is a block diagram illustrating an example application in a microservices architecture in accordance with an embodiment.

FIGS. 5A and 5B are continuous portions of an example data flow diagram illustrating a priori promotion of a transaction to a distributed transaction in a microservices architecture in accordance with an embodiment.

FIG. 6 is an example data flow diagram illustrating a local transaction that is not promoted to a distributed transaction in a microservices architecture in accordance with an embodiment.

FIG. 7 is a flowchart illustrating a priori promotion of a local transaction to a distributed transaction in a microservice architecture in accordance with an embodiment.

FIG. 8 is a block diagram that illustrates a computer system upon which aspects of the illustrative embodiments may be implemented.

FIG. 9 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments attempt to avoid the overhead of using a distributed transaction when involvement of a transaction manager is unnecessary. When a service initiates a transaction, it has a choice of starting a local transaction with its associated resource manager or starting a distributed transaction that will potentially span multiple resource managers. In accordance with the illustrative embodiments, a service initiates a local transaction with its associated resource manager. When the service communicates with another service, it becomes possible that a full distributed transaction may be required. Thus, in response to the initiating service communicating with another service, the local transaction is promoted to a distributed transaction.

This requires knowing what resource manager a service is using and when it makes a service call to another service. By tracking the resource managers a service uses, it is possible to know whether more than one resource manager is being used for a request and, thus, whether coordination of resource managers by a transaction manager using a distributed transaction is required. Once another resource manager is used or a service call is made to another service, the local transaction is promoted to a full distributed transaction. This requires support in the resource manager of the initiating service to promote a local transaction to a distributed transaction.

In accordance with the illustrative embodiments, the decision to promote a transaction is made by the initiating service. If the transaction manager service is required to make the decision to promote, then that requires at least one round-trip from the initiating service to the transaction manager service to indicate a local transaction exists that may need to be promoted. Whether or not the transaction manager determines that local transaction must be promoted, this call is unnecessary if the transaction can stay as a local transaction. Furthermore, commit processing must be handled in part by the transaction manager requiring additional unnecessary network traffic. Making the decision local at the initiating service saves communication overhead whether or not the transaction must be promoted.

The illustrative embodiments allow services to start a transaction that may be able to be handled locally instead of always assuming a distributed transaction is required. With the solution of the illustrative embodiments, the local transaction would get promoted as soon as the call to the other service is made, even if the called service does not update any resource managers. This represents an improvement over the naïve solution that always starts a distributed transaction.

### Microservices Architecture for Distributed Transactions

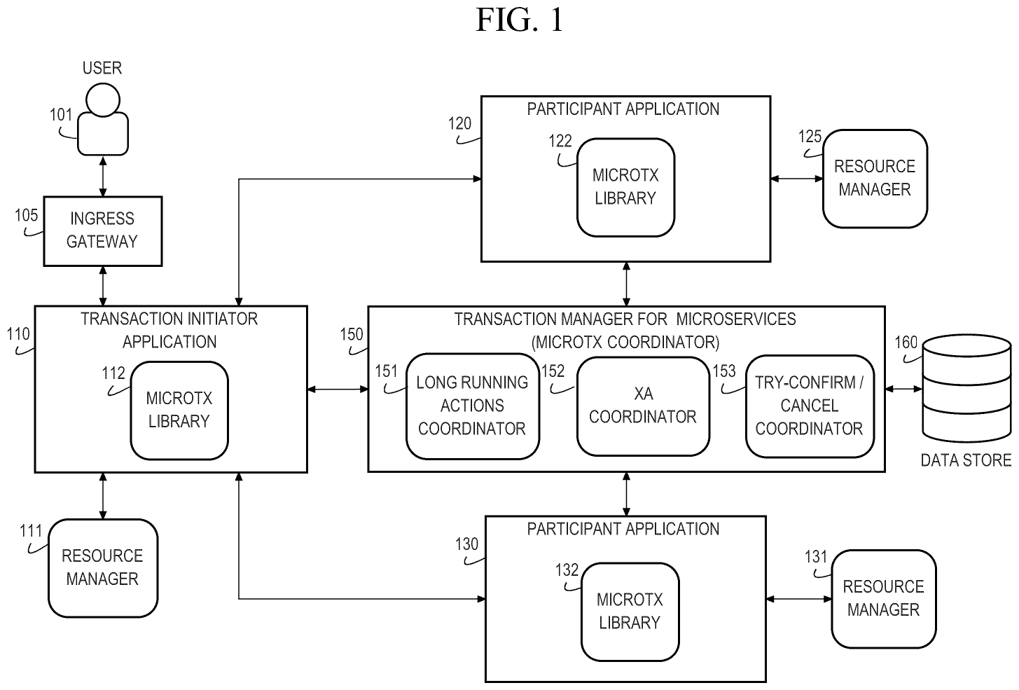

FIG. 1 is a block diagram illustrating a microservices architecture in which aspects of the embodiments can be implemented. In the depicted example, an application is built including a transaction initiator application 110, participant application 120, and participant application 130, which are services in the microservices architecture. User 101 calls transaction initiator application 110 using ingress gateway 105 to initiate a transaction. During execution of the transaction, transaction initiator application 110 can perform the transaction entirely using resources that are local to transaction initiator application 110 using one or more resource managers 115. Alternatively, transaction initiator application 110 can make a service call to participant application 120, participant application 130, or both. Participant application 120 and participant application 130 can also use resources using one or more resource managers 125, 135.

### Transaction Manager

Transaction manager 150, also referred to as microservices transaction (MicroTx) coordinator, is a service that coordinates transactions that involve resource managers at multiple services, such as applications (services) 110, 120, 130, to ensure consistency and atomicity of transactions across services. Each service includes a transaction manager for microservices client library for communicating and coordinating with the transaction manager 150. Thus, transaction initiator application 110 includes MicroTx client library 112, participant application 120 includes MicroTx client library 122, and participant application 130 includes MicroTx client library 132. Transaction initiator application 110 enlists with the transaction manager 150 using the MicroTx client library 112 as a participant of the transaction.

Transaction manager 150 provides a set of REST services including long running actions coordinator 151, extended architecture (XA) coordinator 152, and try-confirm/cancel coordinator 153. Long running actions (LRA) coordinator 151 is a service that participant applications register with and is responsible for driving completion or compensation of a long running action. LRA transactions provide eventual consistency, and users may see inconsistent updates across resources for the duration of the distributed transaction. Development with LRAs can be more complex as users are required to write and test compensate business logic.

Try-confirm/cancel coordinator 153 uses a protocol that has an initiator ask other services to reserve resources or place them in escrow. Once the initiator 110 and all participant services 120, 130 have acquired the necessary reservations, the initiator 110 then asks transaction manager 150 to confirm all of the reservations. During the try phase, all accepted reservations are collected in headers by the MicroTx client library 112. This includes reservations made indirectly by services called by the initiator. By the time the initiator 110 has completed making reservations with service 120 and service 130, the MicroTx client library 112 has collected all the reservations in headers. At this point, in the confirm/cancel phase, the initiator can decide to confirm the reservations, cancel the reservations, or ignore the reservations by letting timeouts eventually cancel the reservations. Try-confirm/cancel coordinator 153 is used for services that need to place resources in reserve.

Transaction manager 150 uses data store 160 as a transaction log store to manage distributed transactions. When transaction initiator application 110 initiates a transaction, transaction manager 150 begins logging the transaction as a distributed transaction. Transaction initiator application 110 may perform operations using resource manager 111 as part of the distributed transaction. When transaction initiator application 110 calls participant application 120, participant application 120 may perform operations using resource manager 125 as a branch transaction that is part of the distributed transaction. Similarly, when transaction initiator application 110 calls participant application 130, participant application 130 may perform operations using resource manager 135 as a branch transaction that is part of the distributed transaction. To be atomic, the distributed transaction must successfully complete and commit all branch transactions. Transaction manager 150 uses data store 160 to log the distributed transaction and all branch transactions to ensure consistency.

### Extended Architecture (XA) Transactions

XA coordinator 152 provides an extended architecture (XA) transaction protocol for applications that require strong global consistency for distributed transactions. XA offers strong data consistency with low development complexity. XA transaction protocol eliminates the need for application specific business log to ensure consistency. Example implementations are described below with reference to the XA transaction protocol for ease of illustration; however, other implementations are within the spirit and scope of the embodiments described herein.

Application services communicate with resource managers using a resource manager interface, and the resource managers return results. An example of a resource manager is a database management system; however, other resource managers may be used, such as messaging services, Java™ application servers, etc. In the embodiments described herein, the resource manager may be any resource manager that supports promotable transactions. Application services communicate with transaction manager using transaction demarcation calls, and the transaction manager returns a status of the transaction. The transaction manager, which includes the MicroTx libraries, makes XA calls to the resource managers, and the resource managers return a status.

XA transactions provides a two-phase commit protocol, which provides strong consistency across multiple resource managers. The XA transaction protocol maintains ACID (Atomicity, Consistency, Isolation, and Durability). The XA transaction protocol is mostly transparent to the application services. Developers only use transaction APIs or annotations to demarcate transaction boundaries (begin, commit, abort, etc.). The XA transaction protocol also has built-in support for many resource managers, such as enterprise databases.

### Interceptors

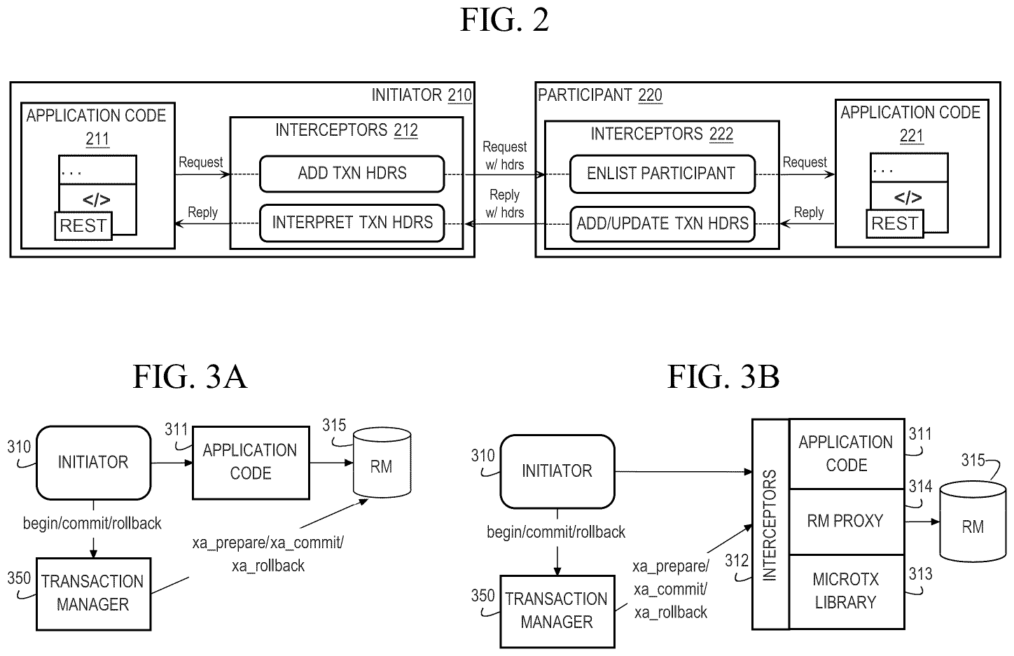

The embodiments use interceptors to simplify application development. FIG. 2 is a block diagram illustrating the use of interceptors in accordance with an embodiment. Application code 211 in initiator service 210 communicates with application code 221 in participant service 220. Application code 211 comprises a REST client that sends a REST request to application code 221, which is also a REST client. Application code 221 processes the request and returns a reply. In initiator service 210, interceptors 212 include logic to intercept an outgoing REST request and add transaction headers to the REST request and logic to interpret transaction headers from a reply received from participant service 220. In participant service 220, interceptors 222 include logic to intercept a REST request received from initiator service 210 and enlist as a participant in the transaction based on the transaction headers in the request. Interceptors 222 also include logic to intercept an outgoing reply and add or update transaction headers in the reply. Interceptors 212, 222 automatically propagate transaction context to other services and handles automatic enlistment of services with the transaction manager.

### Resource Manager Proxy

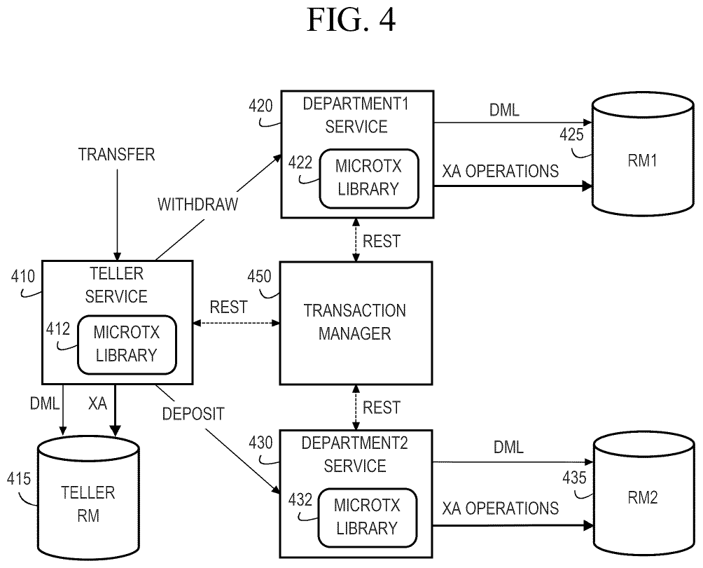

FIG. 3A is a block diagram illustrating extended architecture transaction management between an initiator service and a resource manager in accordance with an embodiment. Initiator 310 initiates a transaction and makes some calls to application code 311, which performs operations on resource manager 315. For example, initiator 310 may be a product ordering service that calls application code 311 of an inventory service, which performs data manipulation language (DML) operations on a database (RM 315). When initiator 310 calls transaction manager 350 to indicate that it wants to begin, commit, or rollback a transaction, the transaction manager 350 performs corresponding XA operations on resource manager 315. Transaction manager 350 normally has its own connection to resource manager 315. This traditional approach requires that the transaction manager 350 has appropriate software libraries to perform operations with the particular resource manager 315 and also to have appropriate credentials.

FIG. 3B is a block diagram illustrating a resource manager proxy for extended architecture transaction management between an initiator service and a resource manager in accordance with an embodiment. In this approach, initiator 310 initiates a transaction and makes some calls to application code 311, which performs operations on resource manager 315; however, when initiator 310 calls transaction manager 350 to indicate that it wants to begin, commit, or rollback a transaction, the transaction manager 350 relays the corresponding XA operations to the participant application code 311. Interceptors 312 directs the XA operations to MicroTx client library 313, which hands the XA calls to resource manager (RM) proxy 314. In one embodiment, RM proxy 314 is a REST service provided by and contained in MicroTx client library 313, thus embedded within the application microservice. MicroTx client library 313 provides REST callbacks for resource manager operations.

RM proxy 315 has the appropriate software libraries and credentials to perform XA operations on resource manager 315. The RM Proxy 315 is resource manager agnostic. It requires that the application use an injected connection to the RM. Depending upon the framework (Helidon, Spring Boot, etc.) and database access (JDBC, Hibernate, etc.) the RM proxy may use an injected XADataSource or an Entity Manager that is using an XADataSource. The RM Proxy in the Java™ case just uses the XAResource of the underlying connection. Thus, both the transaction manager and the RM proxy are agnostic to the resource managers of each of the participant services.

### Example Application in Microservices Architecture

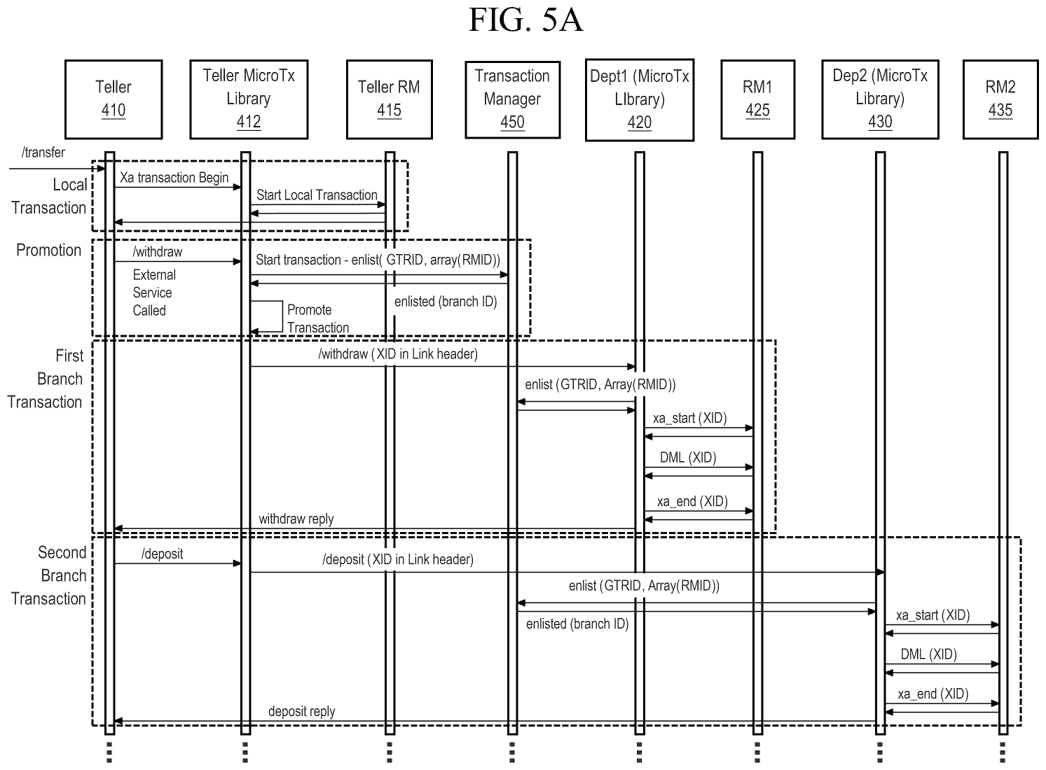

FIG. 4 is a block diagram illustrating an example application in a microservices architecture in accordance with an embodiment. Teller service 410 receives a transfer request from a user and initiates a transaction. As configured, the application is designed to use teller service 410, department1 service 420, and department2 service 430. Teller service 410 includes MicroTx client library 412, department1 service 420 includes MicroTx client library 422, and department2 service 430 includes MicroTx client library 432. Teller service 410 uses teller resource manager (RM) 415. Department1 service 420 uses RM1 425. Department2 service 430 uses RM2 435.

Teller service 410 links with MicroTx client library 412, which sends a REST call to transaction manager 450 to enlist teller service 410 as a participant in the distributed transaction. In response to receiving the transfer request, teller service 410 sends a withdraw request to department1 service 420. Department1 service 420 links with MicroTx client library 422, which sends a REST call to transaction manager 450 to enlist department1 service 420 as a participant in the distributed transaction. The withdrawal is performed as a branch transaction. Department1 service 420 uses XA operations to coordinate the withdrawal transaction as a branch transaction of the distributed transaction for the transfer request. Department1 service 420 uses DML operations to perform operations for the branch transaction on RM1 425.

In response to a reply from department1 service 420 indicating the withdrawal is complete, teller service 410 sends a deposit request to department2 service 430. Department2 service 430 links with MicroTx client library 432, which sends a REST call to transaction manager 450 to enlist department2 service 430 as a participant in the distributed transaction. The deposit is performed as a branch transaction. Department2 service 430 uses XA operations to coordinate the deposit transaction as a branch transaction of the distributed transaction for the transfer request. Department2 service 430 uses DML operations to perform operations for the branch transaction on RM1 435.

In response to a reply from department2 service 430 indicating the deposit is complete, teller service 410 calls the transaction manager to commit the transaction. The entire distributed transaction, including the withdrawal branch transaction and the deposit branch transaction, are committed together. Either the entire distributed transaction completes and commits, or the entire distributed transaction is rolled back.

However, in the current microservices architecture, even if teller service 410 never calls department1 service 420 or department2 service 430, teller service 410 links with MicroTx client library 412, which sends a REST call to transaction manager 450 to enlist teller service 410 as a participant in the distributed transaction. Transaction manager 450 then coordinates the transaction as a distributed transaction even though teller RM 415 may be the only resource manager involved in the transaction. Therefore, the REST call to transaction manager 450 is unnecessary in this case, because the transaction could have been performed as a local transaction.

### A Priori Promotion of Local Transaction to Distributed Transaction

In accordance with an embodiment, MicroTx client library 412 starts the transaction as a local transaction and allows the local transaction to proceed until a call is made to another service. In response to teller service 410 initiating a call to department1 service 420, MicroTx client library 412 then promotes the transaction to a distributed transaction and sends a REST call to transaction manager 450 to enlist teller service 410 as a participant in the distributed transaction. The transaction then proceeds as a distributed transaction. The transaction must also be promoted to a distributed transaction with teller RM 415.

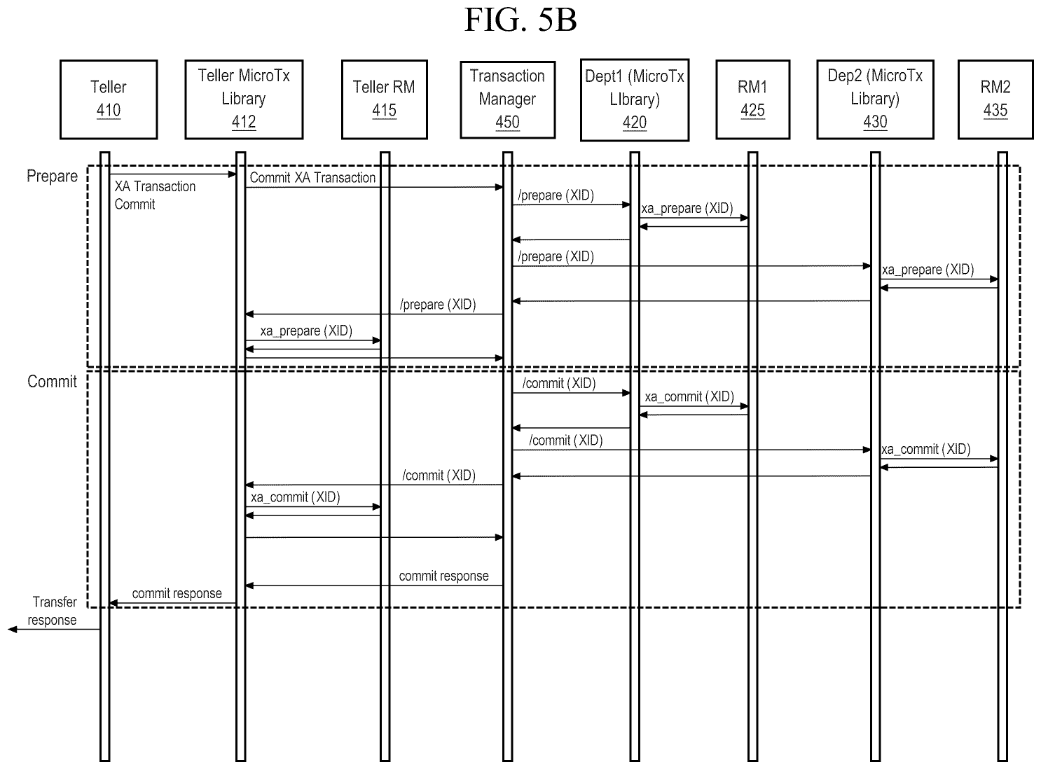

FIGS. 5A and 5B are continuous portions of an example data flow diagram illustrating a priori promotion of a transaction to a distributed transaction in a microservices architecture in accordance with an embodiment. With reference to FIG. 5A, teller service 410 receives a transfer request (/transfer) from a user and issues an XA transaction begin call to initiate a local transaction with teller RM 415. Teller service 410 has not sent a call to another service; therefore, teller MicroTx client library 412 starts a local transaction with teller RM 415. For example, if teller service 410 performs operations on teller RM 415 in the local transaction, then those operations must be committed or rolled back with all other operations in the local transaction.

As part of the transfer transaction, teller service 410 sends a withdraw request to department1 service 420, which includes its MicroTx client library. Teller MicroTx client library 412 detects the call to another service and starts a distributed transaction by enlisting teller service 410 with the transaction manager (MicroTX coordinator) 450. Teller MicroTx client library 412 sends a global transaction identifier (GTRID) and a resource manager identifier (RMID) to the transaction manager 450 and receives a branch ID for operations performed using teller RM 415. Teller MicroTx client library 412 then promotes the transaction such that transaction manager 450 coordinates operations performed using all resource manager as a distributed transaction. All operations that are part of the distributed transaction must be committed or all operations must be rolled back in the distributed transaction.

Teller MicroTx client library 412 then sends the withdraw request (/withdraw) to department1 service 420 with the XA transaction protocol identifier (XID) in the link header. In response to receiving the withdraw request, department1 service 420 enlists with the transaction manager 450 by having its MicroTx client library send a GTRID and RMID for RM1 425. Transaction manager 450 returns a branch ID for operations performed using RM1 425.

Department1 service 420 then sends an XA start with the XID to RM1 425 to tell the resource manager that operations performed on RM1 425 are part of a distributed XA transaction. This begins a branch transaction (/withdraw) between department1 service 420 and RM1 425, which is part of the distributed transaction (/transfer). In this example RM1 425 and RM2 435 are databases. Department1 service 420 then performs one or more DML operations on RM1 425 and finishes by sending an XA end with the XID to RM1 425. When all DML operations are completed, department1 service 420 sends an XA end with the XID to RM1 425 to signal the end of the branch transaction. Department1 service 420 then sends a withdraw reply to teller service 410 indicating completion of the withdraw portion of the distributed transaction.

Teller MicroTx client library 412 then sends the deposit request (/deposit) to department2 service 430 with the XA transaction protocol identifier (XID) in the link header. In response to receiving the deposit request, department2 service 430 enlists with the transaction manager 450 by having its MicroTx client library send a GTRID and RMID for RM2 435. Transaction manager 450 returns a branch ID for operations performed using RM2 435.

Department2 service 430 then sends an XA start with the XID to RM2 435 to tell the resource manager that operations performed on RM2 435 are part of a distributed XA transaction. This begins a branch transaction (/deposit) between department2 service 430 and RM2 435, which is part of the distributed transaction (/transfer). Department2 service 430 then performs one or more DML operations on RM2 435 and finishes by sending an XA end with the XID to RM2 435. When all DML operations are completed, department2 service 430 sends an XA end with the XID to RM2 435 to signal the end of the branch transaction. Department2 service 430 then sends a deposit reply to teller service 410 indicating completion of the deposit portion of the distributed transaction.

Turning to FIG. 5B, with the withdraw and deposit portions of the transfer distributed transaction complete, teller service 410 sends a transaction commit to transaction manager 450 to commit all branch transactions within the distributed transaction. Teller MicroTx client library 412 makes a REST call to transaction manager 450 asking it to commit the transaction, which begins a two-phase commit of all operations within the distributed transaction including a prepare phase and a commit phase.

In the prepare phase, transaction manager 450 sends a prepare message with the XID of the distributed transaction to department1 service 420, which then performs an XA prepare on RM1 425 and returns a result. Transaction manager 450 also sends a prepare message with the XID of the distributed transaction to department2 service 430, which then performs an XA prepare on RM2 435 and returns a result. Transaction manager 450 then sends a prepare message with the XID of the distributed transaction to teller MicroTx client library 412, which then performs an XA prepare on teller RM 415 and returns a result. Note that the order of these events within the prepare and commit phases is irrelevant. They can be done sequentially or in parallel.

In the commit phase, transaction manager 450 sends a commit message with the XID of the distributed transaction to department1 service 420, which then performs an XA commit on RM1 425 and returns a result. Transaction manager 450 also sends a commit message with the XID of the distributed transaction to department2 service 430, which then performs an XA commit on RM2 435 and returns a result. Transaction manager 450 then sends a commit message with the XID of the distributed transaction to teller MicroTx client library 412, which then performs an XA commit on teller RM 415 and returns a result.

After all branch transactions are committed, MicroTx client library 412 sends a commit response for the distributed transaction to teller service 410. After the distributed transaction for the transfer request is committed, teller service 410 sends a response for the transfer request to the user.

As seen in FIG. 5A, teller service begins the transaction as a local transaction, and teller MicroTx client library 412 does not promote the transaction to a distributed transaction until teller service 410 calls another service. When the initiator service makes a call to another service, this indicates that another resource manager might be involved and coordination by transaction manager 450 may be required. Even if the application is built using a plurality of services, the initiator service might not call another service for a given transaction.

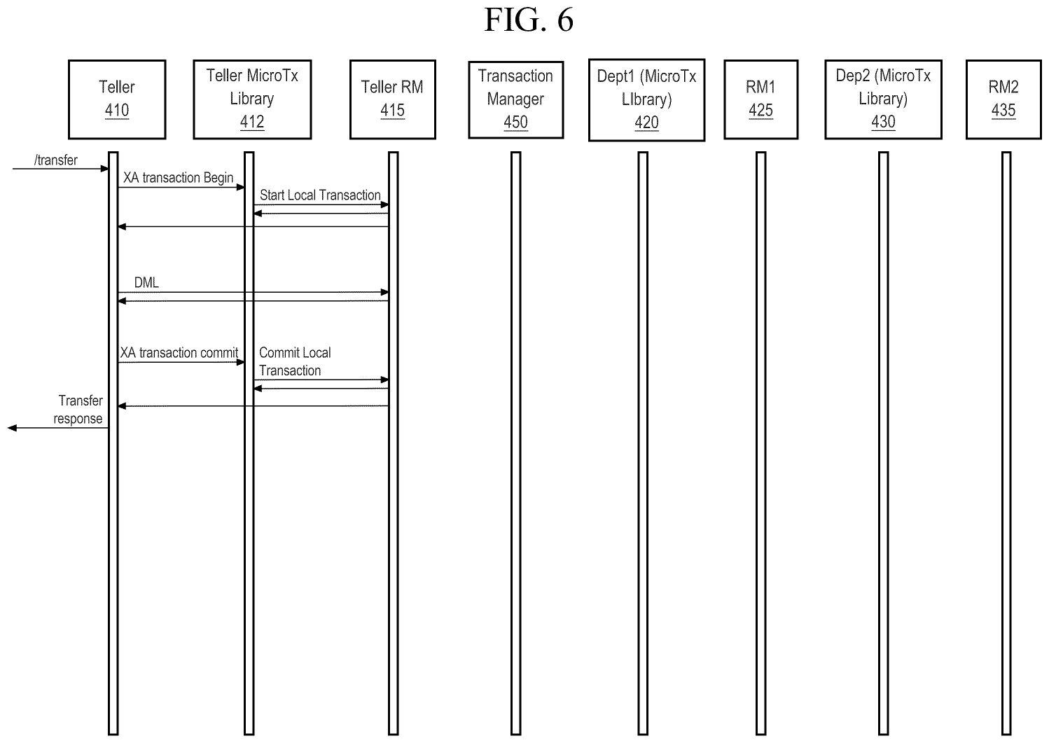

FIG. 6 is an example data flow diagram illustrating a local transaction that is not promoted to a distributed transaction in a microservices architecture in accordance with an embodiment. Teller service 410 receives a transfer request (/transfer) from a user and issues an XA transaction begin call to initiate a local transaction with teller RM 415. Teller service 410 has not sent a call to another service; therefore, teller MicroTx client library 412 starts a local transaction with teller RM 415. For example, if teller service 410 performs operations on teller RM 415 in the local transaction, then those operations must be committed or rolled back with all other operations in the distributed transaction.

In the example shown in FIG. 6, teller service 410 issues an XA transaction commit without calling another service. The transaction remains a local transaction and is not promoted to a distributed transaction. Thus, transaction manager 450 is not involved in the local transaction, and no REST call is sent from teller service 410 to transaction manager 450.

Teller MicroTx client library 412 then commits the local transaction, and teller RM 415 returns a response to teller service 410. After the local transaction commits, teller service 410 returns a response for the transfer request to the user.

### Procedural Overview

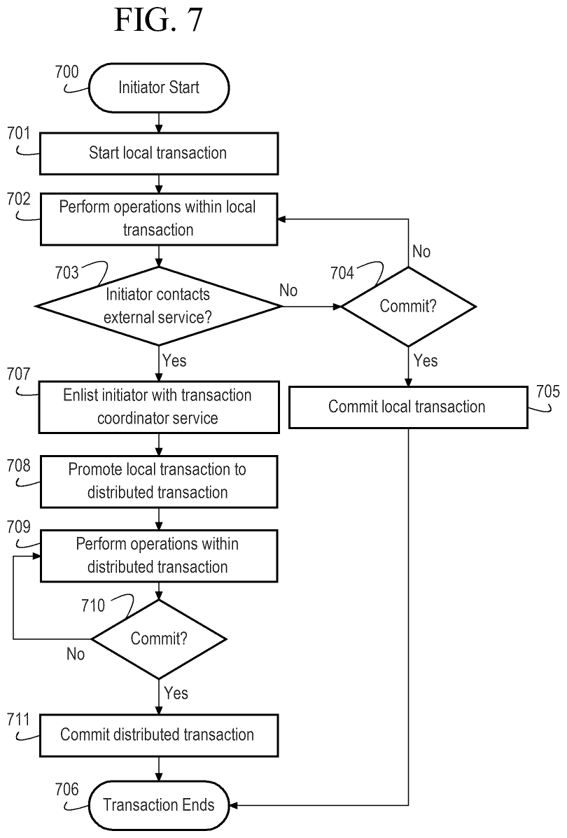

FIG. 7 is a flowchart illustrating a priori promotion of a local transaction to a distributed transaction in a microservice architecture in accordance with an embodiment. Operation begins when an initiator service starts a transaction (block 700). Rather than automatically starting the transaction as a distributed transaction, the MicroTx client library of the initiator service starts the transaction as a local transaction (block 701). The initiator service performs operations, if any, using a resource manager within the local transaction (block 702). The MicroTx client library determines whether the initiator service makes a call to an external service (block 703). If the initiator service does not make a call to an external service (block 703: No), then the MicroTx client library of the initiator service determines whether the initiator begins a commit of the transaction (block 704). If the initiator service does not begin a commit of the transaction (block 704: No), then operation returns to block 702.

The initiator service continues with the local transaction, performing operations, if any, within the local transaction, until the initiator service calls an external service or begins a commit of the transaction. If the initiator service begins a commit of the transaction (block 704: Yes), then the MicroTx client library commits the local transaction (block 705), and the transaction ends (block 706). In this case, the entire transaction completes as a local transaction without involving a transaction manager.

If the initiator service calls an external service (block 703: Yes), then the MicroTx client library enlists the initiator service and its resource manager(s) with the transaction manager service (block 707) and promotes the transaction to a distributed transaction (block 708). The initiator service performs operations within the distributed transaction with coordination from the transaction manager (block 709). These operations may involve calls to other services and resource managers, which will enlist with the transaction manager service. In some cases, the initiator may not perform any operations on other resource managers; however, the transaction is promoted to a distributed transaction based on the possibility that external services may perform operations using one or more resource managers.

The MicroTx client library of the initiator service determines whether the initiator begins a commit of the transaction (block 710). If the initiator service does not begin a commit of the transaction (block 710: No), then operation returns to block 709. The initiator service continues with the distributed transaction, performing operations, if any, within the distributed transaction, until the initiator service begins a commit of the transaction. If the initiator service begins a commit of the transaction (block 710: Yes), then the MicroTx client library commits the distributed transaction (block 711), and the transaction ends (block 706).

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

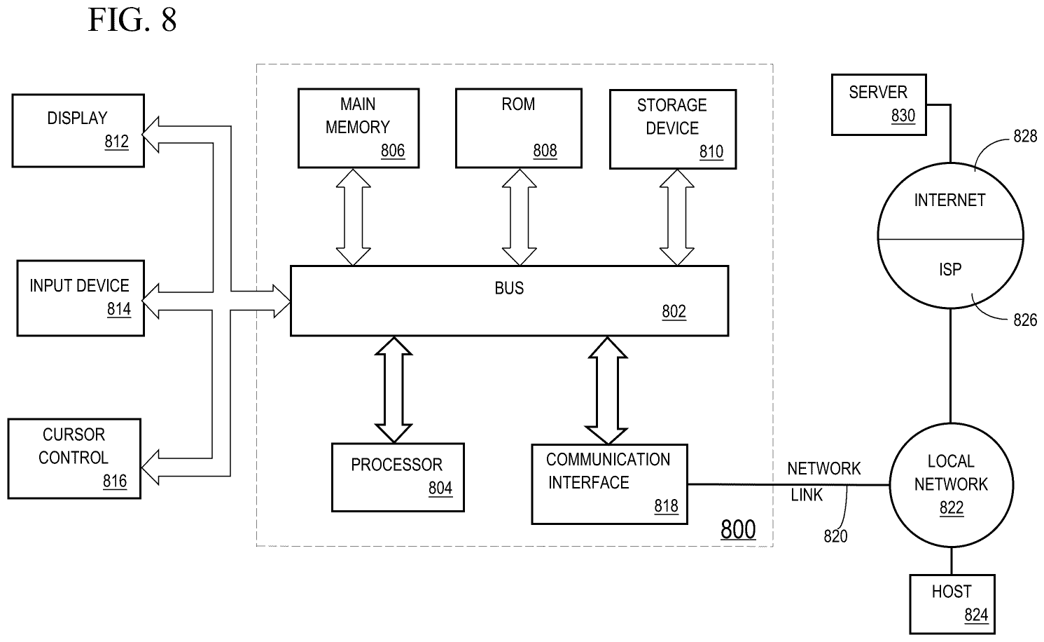

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

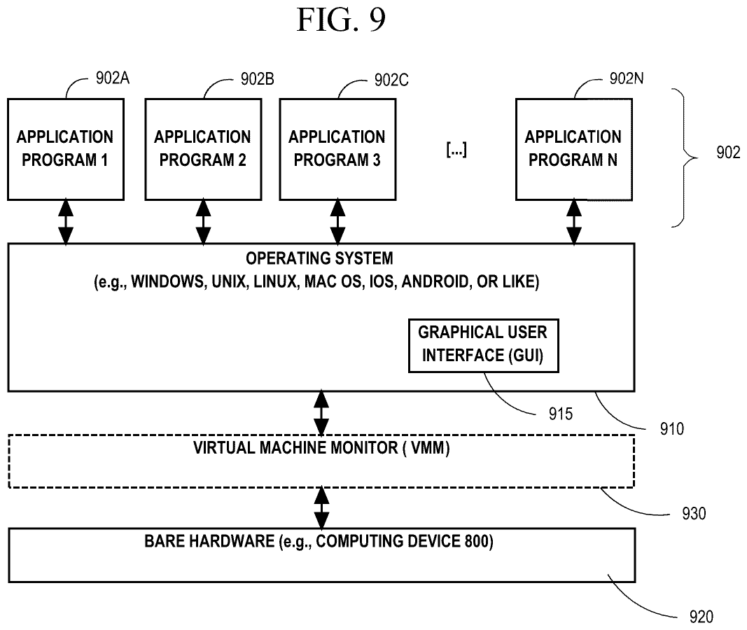

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
in response to an application initiating a transaction with a first service, executing the transaction in the first service as a local transaction; and
in response to the first service initiating a call to a second service as part of the transaction:
promoting the transaction to a distributed transaction, wherein promoting the transaction comprises registering the first service and the second service as part of the distributed transaction with a transaction coordinator service; and
executing the distributed transaction using the transaction coordinator service, wherein the method is performed by one or more computing devices.

2. The method of claim 1, wherein:
the first service executes a first client library of the transaction coordinator service, and
the first client library at the first service detects the call to the second service and promotes the transaction.

3. The method of claim 2, wherein:
the distributed transaction involves one or more operations on a resource manager associated with the second service,
the second service executes a second client library of the transaction coordinator service, and
the second client library intercepts the one or more operations and acts as a proxy for the resource manager.

4. The method of claim 1, wherein:
the distributed transaction involves one or more operations on a resource manager associated with the second service, and
the method further comprises receiving a transaction identifier from the transaction coordinator service and performing the one or more operations using the resource manager associated with the second service using the transaction identifier.

5. The method of claim 1, wherein registering the transaction with the transaction coordinator service comprises making a call from the first service to the transaction coordinator service.

6. The method of claim 5, wherein the call to the transaction coordinator service is made using a representational state transfer (REST) application programming interface.

7. The method of claim 1, wherein registering the transaction with the transaction coordinator service further comprises generating, by the transaction coordinator service, a global transaction identifier for the transaction.

8. The method of claim 1, wherein:
the first service executes one or more operations on a first resource manager associated with the first service as part of the local transaction, and
promoting the transaction further comprises registering the first resource manager as part of the distributed transaction with the transaction coordinator service.

9. The method of claim 1, wherein the call to the second service is made using a representational state transfer (REST) application programming interface.

10. The method of claim 1, wherein:
the distributed transaction involves a plurality of operations on a plurality of resource managers associated with a plurality of services,
the plurality of services include at least the first service and the second service, and
the plurality of operations are committed atomically.

11. One or more non-transitory computer-readable media storing instructions which, when executed by one or more processors, cause performance of:
in response to an application initiating a transaction with a first service, executing the transaction in the first service as a local transaction; and
in response to the first service initiating a call to a second service as part of the transaction:
promoting the transaction to a distributed transaction, wherein promoting the transaction comprises registering the first service and the second service as part of the distributed transaction with a transaction coordinator service; and
executing the distributed transaction using the transaction coordinator service.

12. The one or more non-transitory computer-readable media of claim 11, wherein:
the first service executes a first client library of the transaction coordinator service, and
the first client library at the first service detects the call to the second service and promotes the transaction.

13. The one or more non-transitory computer-readable media of claim 12, wherein:
the distributed transaction involves one or more operations on a resource manager associated with the second service,
the second service executes a second client library of the transaction coordinator service, and
the second client library intercepts the one or more operations and acts as a proxy for the resource manager.

14. The one or more non-transitory computer-readable media of claim 11, wherein:
the distributed transaction involves one or more operations on a resource manager associated with the second service, and
the instructions further cause performance of:
receiving a transaction identifier from the transaction coordinator service; and
performing the one or more operations using the resource manager associated with the second service using the transaction identifier.

15. The one or more non-transitory computer-readable media of claim 11, wherein registering the transaction with the transaction coordinator service comprises making a call from the first service to the transaction coordinator service.

16. The one or more non-transitory computer-readable media of claim 15, wherein the call to the transaction coordinator service is made using a representational state transfer (REST) application programming interface.

17. The one or more non-transitory computer-readable media of claim 11, wherein registering the transaction with the transaction coordinator service further comprises generating, by the transaction coordinator service, a global transaction identifier for the transaction.

18. The one or more non-transitory computer-readable media of claim 11, wherein:
the first service executes one or more operations on a first resource manager associated with the first service as part of the local transaction, and
promoting the transaction further comprises registering the first resource manager as part of the distributed transaction with the transaction coordinator service.

19. The one or more non-transitory computer-readable media of claim 11, wherein the call to the second service is made using a representational state transfer (REST) application programming interface.

20. The one or more non-transitory computer-readable media of claim 11, wherein:
the distributed transaction involves a plurality of operations on a plurality of resource managers associated with a plurality of services,
the plurality of services include at least the first service and the second service, and
the plurality of operations are committed atomically.
